(19) United States
(12) Patent Application Publication
(10) Pub. No.: US 2019/0117006 A1
(43) Pub. Date: Apr. 25, 2019

(54) PORTABLE HYDRATION BOTTLE

(71) Applicant: Platinum Products, LLC, Missoula, MT (US)

(72) Inventor: Anthony CERASANI, Missoula, MT (US)

(21) Appl. No.: 16/096,959

(22) PCT Filed: Apr. 26, 2017
(86) PCT No.: PCT/US2017/029706

§ 371 Date: Oct. 26, 2018

Related U.S. Application Data
(60) Provisional application No. 62/328,521, filed on Apr. 27, 2016.

(51) Int. Cl. A47J 31/00; A47J 31/06; A47J 43/27; B65D 43/02; B65D 23/10; B65D 51/24; A45F 3/18

(52) U.S. Cl. CPC A47J 31/005; A47J 31/0636; A47J 43/27; A45F 3/18; B65D 23/106; B65D 51/242; B65D 43/0231

(57) ABSTRACT

A portable hydration bottle comprises a container that includes a bottle, a lid secured to the bottle, and a cap secured to the lid. The securing can be threaded engagement and the cap can be threaded to the lid in a direction opposite to the threaded engagement of the lid and the bottle. The portable hydration bottle can include multiple handles, such as a first handle at a side thereof and a second handle at a top thereof. Portable hydration bottles can include a strainer and a mixing element coupled to the strainer, as well as a releasable latch to prevent removal of the lid from the bottle.

### CROSS REFERENCE TO RELATED APPLICATION

This application claims the benefit under 35 U.S.C. § 119(e) to U.S. Provisional Application 62/328,521 filed Apr. 27, 2016, which application is incorporated by reference herein in its entirety.

### BACKGROUND

### Technical Field

The present disclosure relates generally to hand-holdable containers and, more particularly, to containers having multi-component lid systems to allow the containers to be opened in different ways for different purposes.

### Description of the Related Art

Hand-holdable containers with removable lids are a well-known means for carrying beverages or other items. Recent designs known as “shaker cups” have become popular due to their portability, ease of use, and ability to aid a user in mixing the contents of the shaker cup. Shaker cups are used to mix and dispense a variety of liquefied foods and beverages. They typically include a means to hold the cup, such as a handle or hand grips, to enable a user to drink the beverage. One common use of a shaker cup is to mix a protein powder with water in the same container from which the user drinks the mixed protein powder and water. Shaker cups can be convenient for users who desire to mix and consume food or beverages while on the go.

A variety of shaker cups are commercially available. A simple shaker cup typically includes a cup and a lid. A user introduces the ingredients to be mixed into the cup, attaches the lid to the cup to seal the items inside the cup, and shakes the sealed cup to mix the ingredients together. Some shaker cups include a whisking or mixing element, which can be attached to the cup or the lid or can be an independent component that moves freely within the shaker cup as the cup is shaken.

### BRIEF SUMMARY

A hand-holdable container may be summarized as including: a bottle including a top wall, a side wall, and a bottom wall that define an interior space, an opening in the top wall that is in fluid communication with the interior space, and a first handle formed in the side wall; a lid that is structured to be threadedly engaged with the top wall of the bottle and to cover the opening in the top wall of the bottle, the lid including a mouth; and a cap that is structured to be threadedly engaged with the lid and that is sized and shaped to cover the mouth of the lid, the cap including a second handle.

hand-holdable container may be summarized as including: a bottle having a top wall and an opening in the top wall; a lid that is structured to be threadedly engaged with the top wall of the bottle in a first rotational direction and to cover the opening in the top wall of the bottle, the lid including a mouth; and a cap that is sized and shaped to cover the mouth of the lid and to be threadedly engaged with the lid in a second rotational direction that is opposite to the first rotational direction.

A hand-holdable container may be summarized as including: a bottle having an interior, a top wall, an opening in the top wall in communication with the interior, and a knob extending upward from the top wall; a lid that is structured to be threadedly engaged with the top wall of the bottle and to cover the opening in the top wall of the bottle, the lid including a mouth and a releasable latch structured to be locked to the knob; and a cap that is structured to be threadedly engaged with the lid and to cover the mouth of the lid.

A hand-holdable container may be summarized as including: a bottle having an interior, a top wall, and an opening in the top wall in communication with the interior; a lid that is structured to be threadedly engaged with the top wall of the bottle and to cover the opening in the top wall of the bottle, the lid including a mouth and a strainer that is structured to extend downward into the bottle; a mixing element structured to be coupled to the strainer and to extend into the bottle from the strainer; and a cap that is structured to be threadedly engaged with the lid and to cover the mouth of the lid.

### BRIEF DESCRIPTION OF THE SEVERAL VIEWS OF THE DRAWINGS

The foregoing features and advantages of the present disclosure will be more readily appreciated as the same become better understood from the following detailed description when taken in conjunction with the accompanying drawings, wherein:

FIG. 1 is an isometric view of a portable hydration bottle, according to at least one implementation formed in accordance with the present disclosure;

FIG. 2 is an isometric view of the side of the portable hydration bottle shown in FIG. 1;

FIG. 3 is an isometric view of the bottom of the portable hydration bottle shown in FIG. 2;

FIG. 4 is a pictorial view showing a bottom of a cap of the portable hydration bottle of FIG. 1;

FIG. 5 is a pictorial view of a portion of the portable hydration bottle of FIG. 1 with the cap removed to show a cap seal;

FIG. 6 is a pictorial view of the portion of the portable hydration bottle of FIG. 5 with the cap seal removed;

FIG. 7 is an enlarged pictorial view showing a bottom of the lid of the portable hydration bottle of FIG. 1 without the mixing element;

FIG. 8 is an enlarged pictorial view showing the bottom of the lid of the portable hydration bottle of FIG. 1 with the mixing element attached thereto;

FIG. 9 is a pictorial view of the lid of the portable hydration bottle of FIG. 1 with the cap seal and a mixing element;

FIG. 10 is a pictorial view of a top of the portable hydration bottle of FIG. 1 with the cap, cap seal, and a lid removed to reveal a lid seal;

FIG. 11 is a pictorial view of the portable hydration bottle of FIG. 10 showing the lid seal removed;

FIG. 12 is a cross-sectional view of a top section of the portable hydration bottle of FIG. 1 illustrating interactions between the cap, the lid, and the bottle; and

FIG. 13 is another cross-sectional view of a bottom section of the portable hydration bottle of FIG. 1 showing the connection of the mixing element to the bottom of the bottle.

### DETAILED DESCRIPTION

In the following description, certain specific details are set forth in order to provide a thorough understanding of various disclosed implementations. However, one skilled in the relevant art will recognize that implementations may be practiced without one or more of these specific details, or with other methods, components, materials, etc. In other instances; well-known structures or components or both associated with hand-holdable containers have not been shown or described, such as handles, sealing means for lids, and mixing elements, in order to avoid unnecessarily obscuring descriptions of the implementations.

Unless the context requires otherwise, throughout the specification and claims that follow, the word “comprise” and variations thereof, such as “comprises” and “comprising” are to be construed in an open inclusive sense, that is, as “including, but not limited to.” The foregoing applies equally to the words “including” and “having.”

Reference throughout this description to “one implementation” or “an implementation” means that a particular feature, structure, or characteristic described in connection with the implementation is included in at least one implementation. Thus, the appearance of the phrases “in one implementation” or “in an implementation” in various places throughout the specification are not necessarily all referring to the same implementation. Furthermore, the particular features, structures, or characteristics may be combined in any suitable manner in one or more implementations.

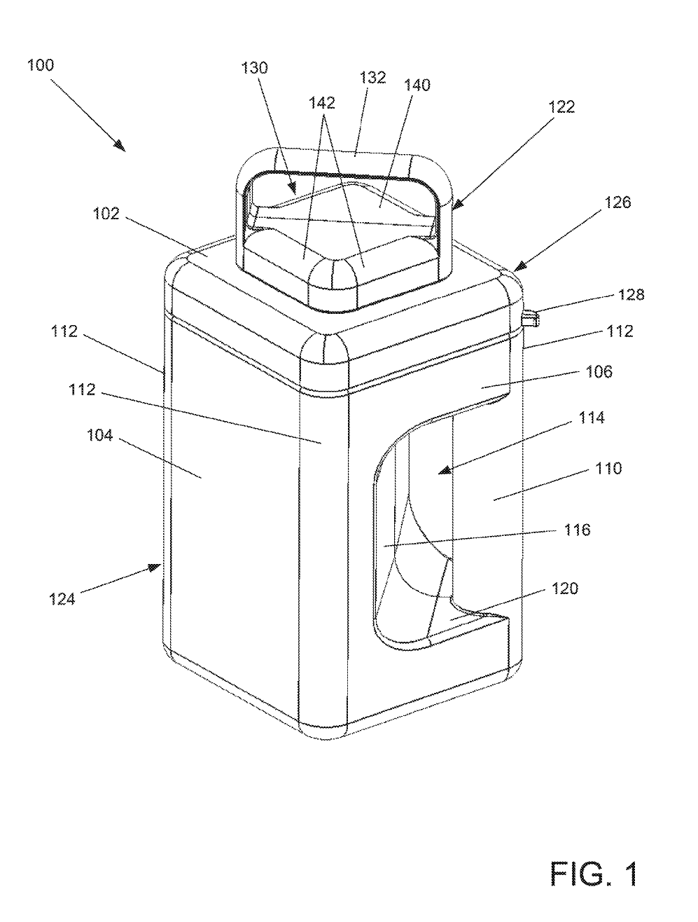

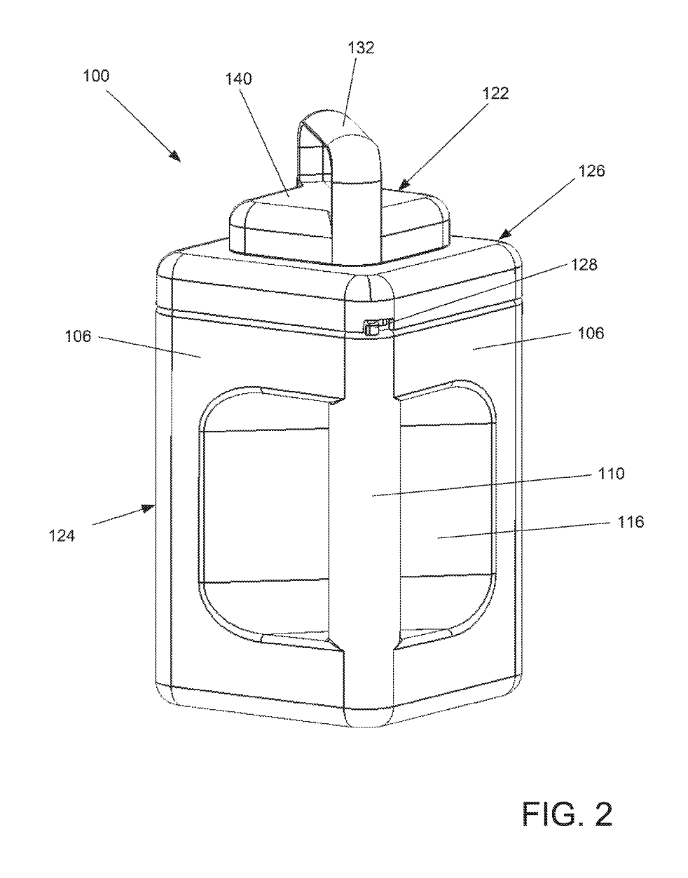

FIGS. 1-3 illustrate from three different angles a hand-holdable container 100 that includes a main body or bottle 124 (e.g., an 80 ounce bottle 124), a lid 126 mounted on the bottle 124, and a cap 122 mounted on the lid 126. The container 100 has a shape generally comprising a rectangular prism with rounded edges. It should be understood that cubed shape and the radius of curvature of these rounded corners and other edges described herein are a matter of design choice. The size and symmetry of the container 100 is designed to present an attractive aesthetic appearance to consumers and have no intended functional purpose. The container 100 includes a top wall 102 formed in the lid 126, two first, flat side walls 104 formed in the bottle 124, two second side walls 106, formed in the bottle 124, into which a side handle 110 is formed, and a bottom wall 108 formed in the bottle 124, The walls 102, 104, 106, and 108 meet each other at twelve edges 112 of the rectangular prism, which are curved or rounded, preferably having a constant radius of curvature.

The container 100 includes a cutout portion 114 that extends diagonally between the two second side walls 106 and in which is located the side handle 110. The cutout portion 114 is bounded at its inner periphery by a diagonal wall 116 extending between the two second side walls 106, at its upper periphery by an upper wall 118 extending between the diagonal wall 116 and the side handle 110, and at its lower periphery by a lower wall 120 extending between the diagonal wall 116 and the side handle 110. Transitions between the upper wall 118, the diagonal wall 116, the lower wall 120, and the two second side walls 106 are curved or rounded. The side handle 110 has a cylindrical shape having a radius of curvature matching the radius of curvature of the edges 112, so that the edge 112 between the two second side walls 106 seamlessly forms a portion of the side handle 110. The degree of curvature or radius of these described components and features is again a matter of design choice for aesthetic purposes as discussed above. While the handle 110 is cylindrical, it can have other geometric shapes, although the cylindrical shape is chosen to provide uniformity in appearance with the other rounded features of the container 100.

The lid 126 includes a releasable latch (described further below) that includes a button 128 that is actuated by a user to release the latch and thereby enable a user to unscrew the lid 126. The cap 122 is mounted to the top wall 102 of the lid 126, and it includes a main body 130 secured to the top wall 102 and a top handle 132 that extends upwardly from the main body 130 of the cap 122. The main body 130 of the cap 122 has a shape generally comprising a square top wall 140 with curved side walls 142 that extend from the square top wall 140 downwards to meet the top wall 102 of the lid 126. The top handle 132 extends upward from the main body 130 and diagonally across the main body 130 between two opposite corners of the square top wall 140 of the main body 130. The shape of the top handle 132 as well as its cross-sectional diameter is selected for aesthetic reasons, in particular to complement the aesthetic appearance of the bottle 124 with the side handle 110, cap 122, and lid 126.

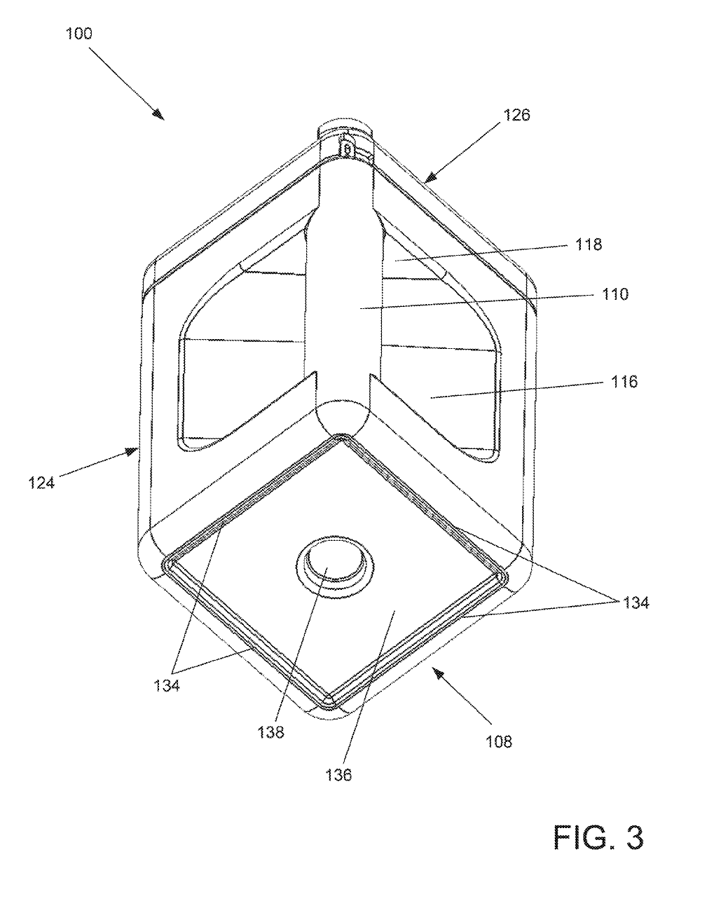

As illustrated in FIG. 3, the bottom wall 108 includes a peripheral rim portion 134 that includes four peripheral edges of the bottom wall 108. The peripheral rim portion 134 extends around the periphery of the bottom wall 108 and forms the lowest portion or bottom end of the container 100. The bottom wall 108 also includes a raised central portion 136 that is raised upward relative to the rim portion 134 and that spans between the four peripheral edges of the rim portion 134. The bottom wall 108 also includes an indentation 138 that is formed at the center of the bottom wall 108, and that is raised inwardly towards the interior relative to the central portion 136. Details of the bottom wall 108, including the rim portion 134, central portion 136, and indentation 138, are also visible in FIG. 13.

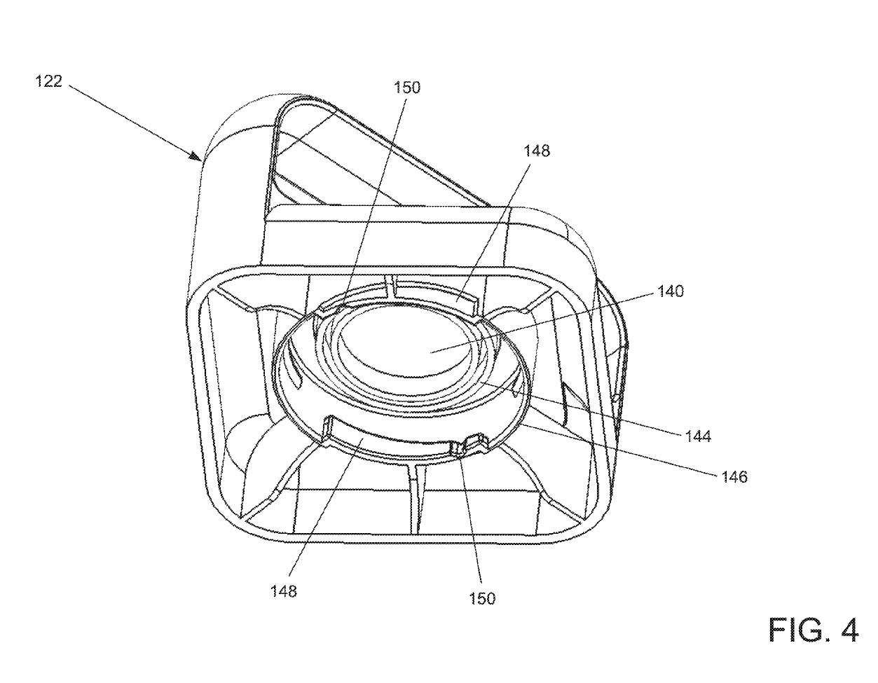

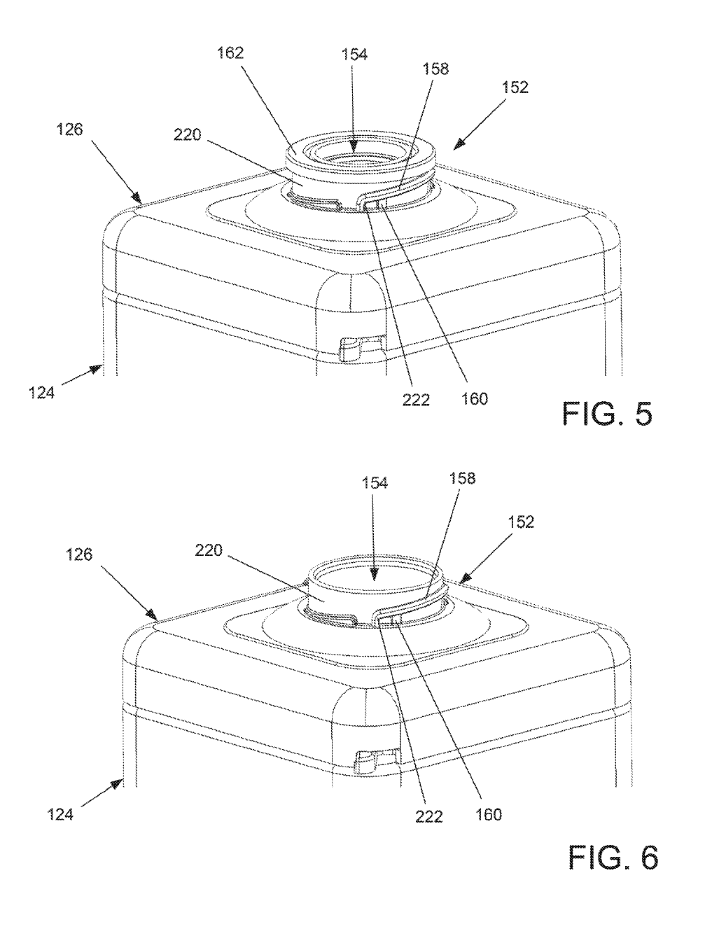

FIG. 4 illustrates the interior or underside of the cap 122 removed from the rest of the container 100. The cap 122 includes a first, inner cylindrical wall 144 extending downward from its top wall 140 and a second, outer cylindrical wall 146 also extending downward from its top wall 140. An annular space, which can also be referred to as a retention groove, is bounded between the inner and outer cylindrical walls 144, 146. A cap seal 162 (which can also be referred to as a cap gasket, and which is described further below with reference to FIG. 5) is seated and compressed, such as in a press-fit arrangement, within the annular space such that the cap seal 162 is secured to the cap 122. When the cap 122 is placed on the lid 126, the cap seal 162 seals the cap 122 to the lid 126. The cap 122 also includes a plurality of arcuate wedges 148 extending into the annular space from the outer cylindrical wall 146. Each of the wedges 148 extends and curves partially around the inner surface of the outer cylindrical wall 146 from a first end of the wedge 148 having a first height to a second end of the wedge 148 having a second height less than the first height. The wedges 148 are used by a user of the container 100 to screw the cap 122 onto threads of the lid 126, as discussed further below. Each of the wedges 148 also includes a respective vertical groove 150 that is formed near the second end of the wedge 148 and that is engaged with a ridge of the lid 126 to releasably secure or lock the cap 122 to the lid 126, as discussed further below.

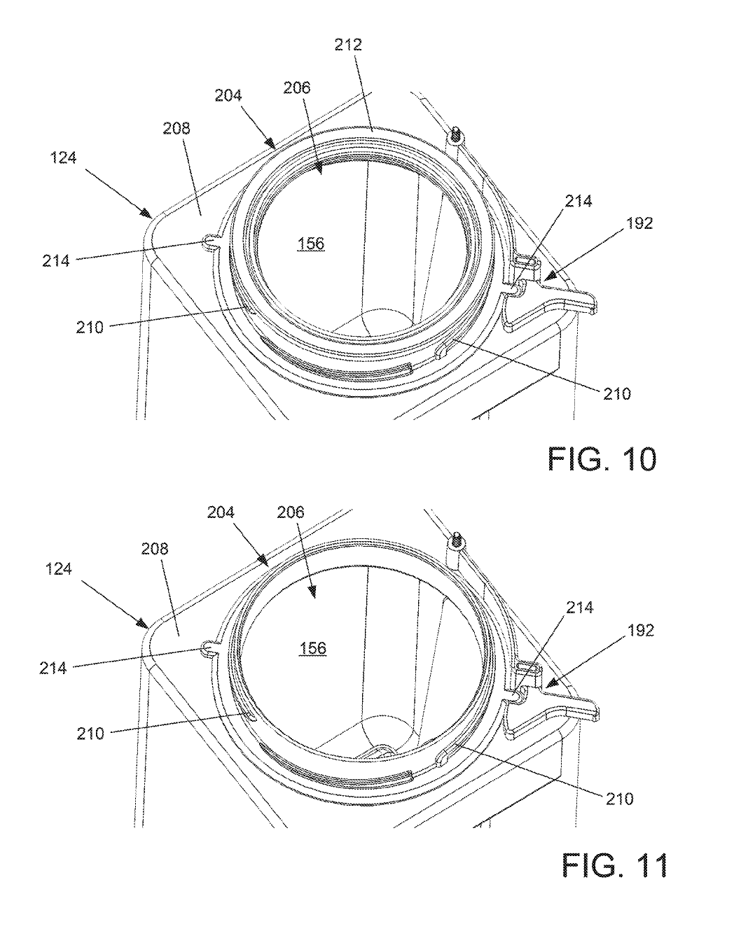

FIGS. 5 and 6 illustrate the upper portion of the container 100, including the bottle 124 and the lid 126 without the cap 122. As illustrated in FIGS. 5 and 6, the lid 126 includes a spout 152 having a mouth 154. The mouth provides an opening at the top of the container 100 that is in fluid communication with an internal or interior space 156 (see FIGS. 10 and 11) and provides fluid communication from within the container 100 to an external environment. A user can fill the container 100, drink a beverage held within the container 100, and pour a fluid held within the container 100 through the mouth 154.

The spout 152 includes a hollow cylinder 220 that extends upwards from the top surface 102 of the lid 126, and threads 158 extending helically around an outer surface of the hollow cylinder. At a location near the end 222 of each of the helical threads 158 where the threads 158 approach the bottom of the hollow cylinder of the spout 152, respective vertically extending ridges 160 extend from the bottom of the hollow cylinder of the spout 152 to the threads 158.

FIG. 5 shows the container 100 without the cap 122, but with a cap seal 162, which can be formed from silicone, positioned at the top of the spout 152. FIG. 6 shows the container 100 without the cap 122 and without the cap seal 162. The cap seal 162 is sized and shaped to seal the cap 122 to the lid 126 when the cap 122 is secured to the lid 126 to prevent the contents of the container 100 leaking out between the cap 122 and the lid 126.

The cap 122 is secured to the lid 126 by screwing the cap 122 onto the lid 126, such as by engaging the curved wedges 148 with the helical threads 158 and turning the cap 122 until the vertical grooves 150 are engaged with the vertical ridges 160 (e.g., for a quarter-turn) to lock the cap 122 in place on the lid 126. As the cap 122 is secured to the lid 126 in this manner, the cap seal 162 is compressed within the annular space of the cap 122 between the top wall 140 of the cap 122 and the top end of the spout 152, thereby sealing the cap 122 to the lid 126. For container 100, the cap 122 is turned clockwise with respect to the lid 126 when looking down on the container 100 to threadably fasten the cap 122 onto the lid 126. In alternative implementations, the curved wedges 148 and helical threads 158 can be structured so that the cap 122 can be turned counter-clockwise to attach the cap 122 to the lid 126.

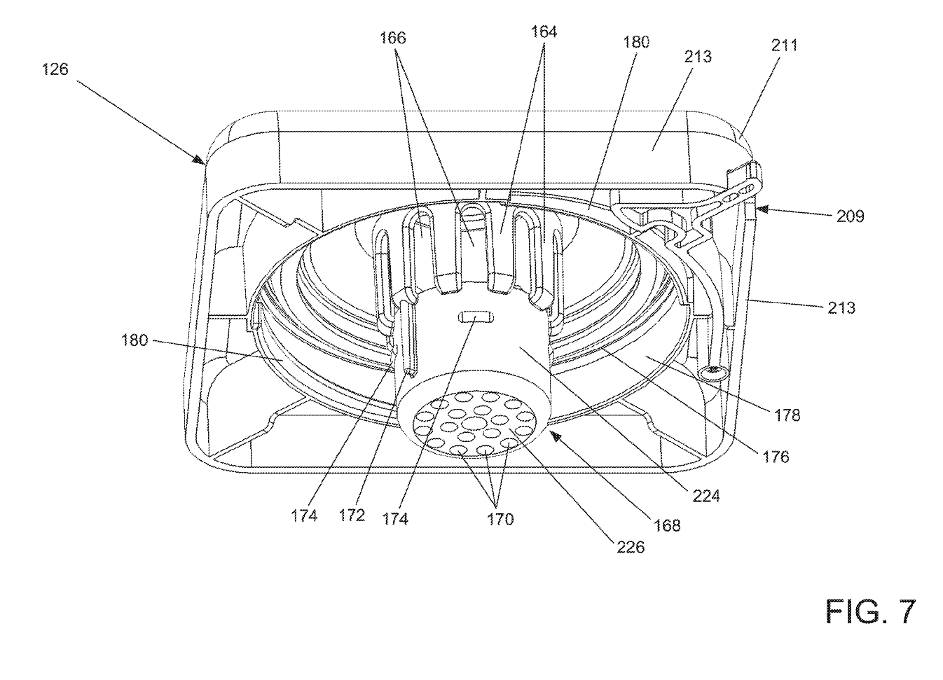

FIG. 7 illustrates the interior side of the lid 126 isolated from the rest of the container 100. The lid 126 includes a plurality of spaced apart arms 164 extending downward from the mouth 154 in a radial pattern to form a plurality of open slots 166 positioned between adjacent arms 164. Ideally the slots 166 have a width that is the same or wider than the width of the arms 164. A strainer 168 is coupled to the bottom end of each of the arms 164 and extends downward from the arms 164 towards the interior of the container 100. The strainer 168 is formed of a hollow cylindrical body 224 and a bottom end 226 having a plurality of open holes 170 to provide fluid communication to an interior of the strainer 168. The strainer 168 also includes a vertical or longitudinal ridge 172 extending radially outward from the cylindrical body along its height, and a plurality of partial circumferential ridges 174 extending away from the lid 126 towards the interior of the container 100 and outward from the exterior side wall of the cylindrical body along a portion of its circumference. The ridges 172 and 174 are used to couple a mixing element 182 to the strainer 168, as described further below.

As shown in FIG. 7, the lid 126 also includes a first, inner cylindrical wall 176 extending downward from its top wall 102 and a second, outer cylindrical wall 178 also extending downward from its top wall 102. An annular space, which can also be referred to as a retention groove, is bounded between the inner and outer cylindrical walls 176, 178. A lid seal 212 (which can also be referred to as a lid gasket, and which is described further below with reference to FIG. 10) is seated and compressed, such as in a press-fit arrangement, within the annular space such that the lid seal 212 is secured to the lid 126. When the lid 126 is placed on the bottle 124, the lid seal 212 seals the lid 126 to the bottle 124. The lid 126 also includes a plurality of arcuate wedges 180 extending into the annular space from the outer cylindrical wall 178. Each of the wedges 180 extends and curves partially around the interior surface of the outer cylindrical wall 178 from a first end of the wedge 180 having a first height to a second end of the wedge 180 having a second height less than the first height. The wedges 180 are sized and shaped to secure the lid 126 onto the bottle 124, as discussed further below.

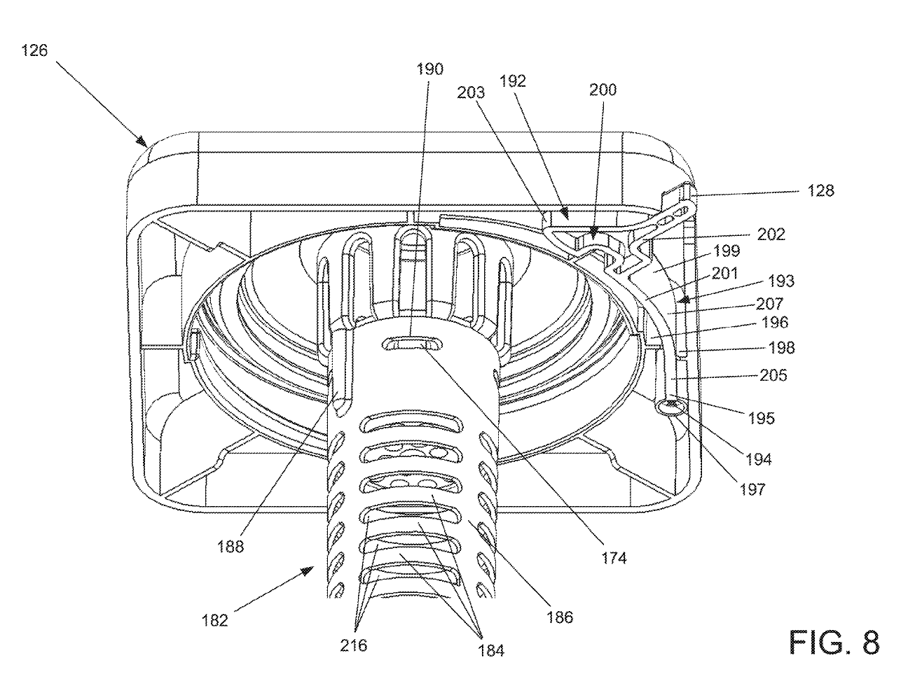

FIG. 8 illustrates the lid 126 of FIG. 7 and further includes an elongate mixing element 182 coupled to the strainer 168. A plurality of elongated arcuate openings 216 are arranged circumferentially around the mixing element 182 and in fluid communication with the interior. A plurality of circular members 184 and a plurality of ribs 186 are coupled together to form a network of struts in a hollow cylindrical shape that extends from a top end to a bottom end of the mixing element 182. The network of struts defines the plurality of openings 216 in the mixing element 182 that are larger than the holes 170 in the bottom end of the strainer 168. The strainer 168 and the mixing element 182 form a dual-compartment structure that can be used in various ways. For example, the strainer 168 can be used to hold a first set of items such as pills and the mixing element 182 can be used to hold a second set of items such as fruit. The strainer 168 and mixing element 182 are sized and shaped to keep the first and second sets of items separated from one another and separated from any items held in the rest of the container 100. Fluids or powders held in the container 100 can mix with items in the strainer 168 and mixing element 182 through the holes 170 in the bottom end of the strainer 168. As another example, the mixing element 182 can be used to mix or break up ingredients held in the container 100, such as by actively shaking the container or passively when the container 100 is shaken while walking or during transport. For example, fruit can be held in the mixing element 182 and can be infused into a fluid held in the container 100 by shaking the container 100. In such an implementation, the mixing element 182 would be referred to as a fruit infuser.

At a top end of the mixing element 182 is a vertical groove 188 extending radially outward from the mixing element 182 along a portion of its length and a plurality of partial circumferential openings 190 extending along a portion of a circumference of the mixing element 182. The vertical groove 188 and circumferential openings 190 correspond to the ridges 172 and 174, respectively, and are used to couple the mixing element 182 to the strainer 168. For example, the mixing element 182 has an inner diameter approximating an outer diameter of the strainer 168. A user can slide the mixing element 182 over the strainer 168, with the ridge 172 engaging the groove 188, until the ridges 174 snap into the openings 190 and thereby lock the mixing element 182 to the strainer 168.

FIG. 8 also shows the lid 126 having a releasable latch 192 coupled to the rest of the lid 126 by a screw 194. The latch 192, which is also shown in FIGS. 10 and 11, has a unitary, elongate, arcuate body 193 with a rectangular cross-sectional shape having opposing long sides 199 and perpendicular short sides 201. A first end 195 of the body 193 has a cylindrical anchor point 197 with a longitudinal axial bore sized and shaped to receive the screw 194 that threadably attaches the first end 195 to the lid 126. The longitudinal axial bore is sized to permit the latch 192 to rotate about the screw 194. When so mounted, the arcuate body 193 is oriented with the long sides 199 of the body 193 perpendicular to the lid 126. The elongate arcuate body 193 extends from the first end 195 to a second end 203 with a first section 205 that is straight and a second section 207 having a radius of curvature that is substantially constant.

The second end 203 of the releasable latch 192 includes a notch 200 facing inward toward the outer cylindrical wall 178 from the second end 203 of the latch 192, and an actuation arm 202 extending outwardly from the arcuate body 193 in a direction opposite the notch 200. The notch 200 and the actuation arm 202 are integrally formed with the latch 192, preferably by having the body 193 curve inward to form the notch 200 and curve outward to form the actuation arm 202. The exact radius of curvature of the actuation arm 202 visible to consumers is a matter of design choice and is selected to aesthetically match the other curvatures in the container 100 to form an overall appealing appearance to consumers. Ideally, the notch 200 and the actuation arm 202 are aligned so the notch 200 extends towards the actuation arm 202 that in turns extends in the same direction and away from the notch 200. The actuation arm 202 extends away from the notch 200 and through a matching opening 209 in a corner 211 of a side wall 213 of the lid 126 (see FIG. 7).

As such, the actuation arm 202 forms a button 128 that can be pushed by a user, which causes the resilient arcuate body 193 to bend. Preferably the body 193 is held in place by a first stabilizer fin 196 extending outwardly from the outer cylindrical wall 178 and by a second stabilizer or fin 198 extending inwardly from the side wall of the lid 126 so that the long sides 199 of the body 193 bear against the fins 196, 198 and maintain the actuation arm 202 in an outwardly located position relative to the lid 126. The actuation arm 202 can be rigid relative to the arcuate body of the latch 192, so that a user can push the button 128 to bend the arcuate body 193 of the latch 192 and move the notch 200 outward and away from an engaging member or knob 214, as described further with regard to FIGS. 10 and 11. For the container 100, the latch 192 is biased inward, toward a locking configuration, and the button 128 can be pushed by a user counter-clockwise when looking down on the container 100 to move the notch 200 radially outward toward a release configuration and thereby release the latch 192. In alternative implementations, the lid 126 and the latch 192 can be structured so that the button can be pushed clockwise to release the latch.

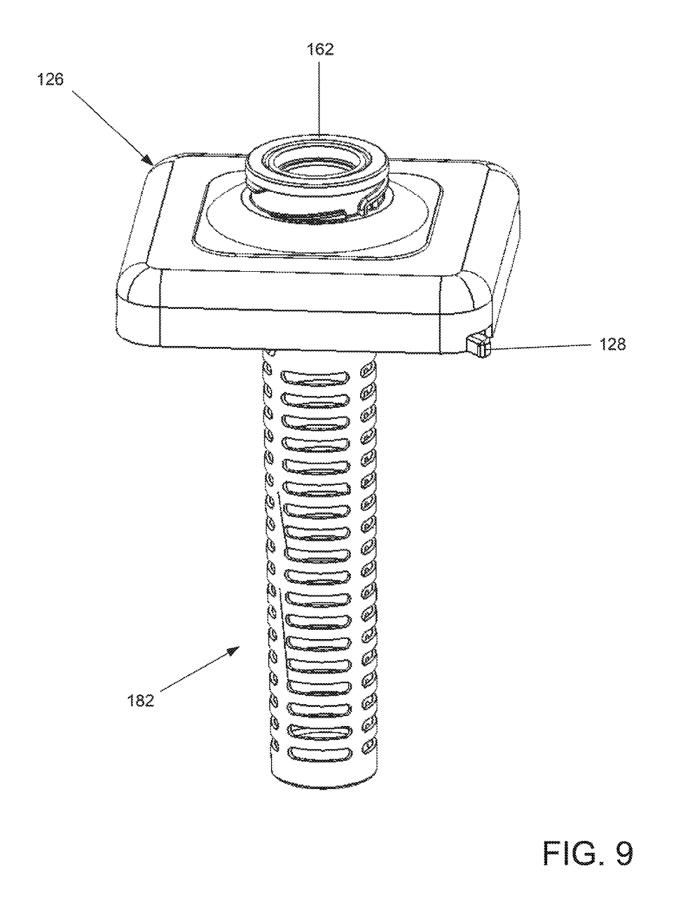

FIG. 9 illustrates the lid 126, cap seal 162, button 128, and mixing element 182 assembled together and isolated from the rest of the container 100. FIGS. 10 and 11 illustrate the bottle 124 without the cap 122 and without the lid 126. As illustrated in FIGS. 10 and 11, the bottle 124 includes a spout 204 having a mouth 206. The mouth 206 provides an opening at the top of the bottle 124 that is similar to, but larger than, the opening of the mouth 154 of the lid 126. For example, the mouth 206 can have a diameter of about 3.75 inches, or wide enough to allow a human hand to enter the bottle 124. Thus, the lid 126 is removable from the bottle 124 to provide a user with a larger opening to the container 100, such as to make it easier for the user to clean the interior space 156 of the container 100. The spout 204 includes a hollow cylinder that extends upwards from a top surface 208 of the bottle 124, and includes threads 210 extending helically around an outer surface of the hollow cylinder. The spout 204 also includes a pair of knobs 214 extending upward from the top surface 208 of the bottle 124 and outward from the hollow cylinder of the spout 204. The knobs 214 are spaced apart from one another by about 180° around the hollow cylinder of the spout 204, and are structured to engage with the notch 200 of the releasable latch 192.

FIG. 10 shows the bottle 124 with a lid seal 212, which can be formed from silicone, positioned at the top of the spout 204. FIG. 11 shows the bottle 124 without the lid seal 212. The lid seal 212 seals the lid 126 to the bottle 124 when the lid 126 is secured to the bottle 124 to prevent the contents of the container 100 leaking out between the lid 126 and the bottle 124. For example, the lid 126 can be secured to the bottle 124 by screwing the lid 126 onto the bottle 124, such as by engaging the curved wedges 180 with the helical threads 210 and turning the lid 126 clockwise until the lid 126 is secured on the bottle 124 and one of the knobs 214 is engaged with the notch 200 of the releasable latch 192, as shown in FIGS. 10 and 11, to lock the lid 126 in place. Securing the lid 126 to the bottle 124 can include turning the lid 126 for a quarter turn. To remove the lid 126 from the bottle 124, the user can push the button 128 in a counter-clockwise direction to release the latch 192 and notch 200 from the knob 214, and then turn the lid 126 counter-clockwise to unscrew the lid 126 from the bottle 124. Removing the lid 126 from the bottle 124 can include turning the lid 126 for a quarter turn. The latch 192 and screw 194 are illustrated in FIGS. 10 and 11 for purposes of clarity only—in practice they are coupled to the lid 126 and would be removed from the bottle 124 when the lid 126 is removed from the bottle 124.

As the lid 126 is secured to the bottle 124 in this manner, the lid seal 212 is compressed within the annular space of the lid 126 between the top wall 102 of the lid 126 and the top end of the spout 204, thereby sealing the lid 126 to the bottle 124. For the container 100, the lid 126 is turned clockwise with respect to the bottle 124 when looking down on the container 100 to screw the lid 126 onto the bottle 124. In alternative implementations, the curved wedges 180 and helical threads 210 can be structured so that the lid 126 can be turned counter-clockwise to screw the lid 126 to the bottle 124.

In some implementations, the direction in which the cap 122 is turned to secure the cap 122 to the lid 126 is the same as the direction in which the lid 126 is turned to secure the lid 126 to the bottle 124. In other implementations, the direction in which the cap 122 is turned to secure the cap 122 to the lid 126 is the opposite of the direction in which the lid 126 is turned to secure the lid 126 to the bottle 124. Such implementations prevent or reduce the chance that the lid 126 is unintentionally unsecured from the bottle 124 when the cap 122 is removed from the lid 126, and that the cap 122 is unintentionally unsecured from the lid 126 when the lid 126 is removed from the bottle 124.

In some implementations, the direction in which the button 128 is pressed to release the latch 192 from the knob 214 is the same as the direction in which the lid 126 is turned to remove the lid 126 from the bottle 124. Such implementations make it easier for a user to remove the lid 126 from the bottle 124. In other implementations, the direction in which the button 128 is pressed to release the latch 192 from the knob 214 is the opposite of the direction in which the lid 126 is turned to secure the lid 126 to the bottle 124. Such implementations make it more difficult for a user to remove the lid 126 from the bottle 124, such as to child-proof the container 100,

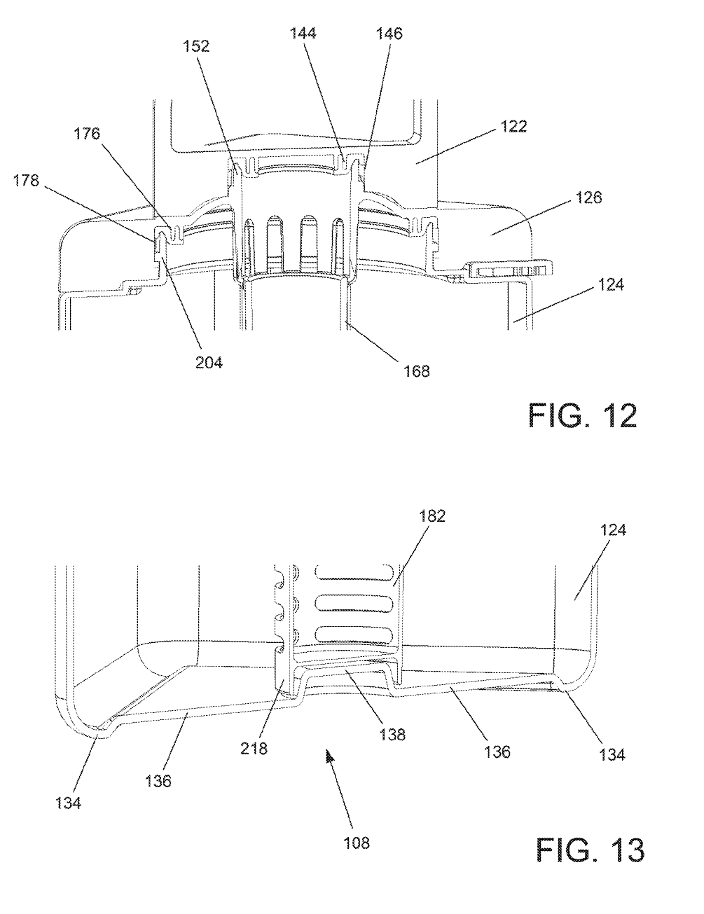

FIG. 12 illustrates a cross-sectional view of a top portion of the assembled container 100, showing the connections between the bottle 124, the lid 126, and the cap 122. FIG. 13 illustrates a cross-sectional view of a bottom portion of the assembled container 100, showing the interaction between a bottom end of the mixing element 182 and the bottom wall 108 of the bottle 124, including the peripheral rim portion 134, the raised central portion 136, and the indentation 138. As illustrated in FIG. 13, a bottom end portion of the mixing element 138 includes a hollow cylindrical rim 218 extending downward and engaging the indentation 138 in the bottom of the bottle 124. An inner surface of the rim 218 engages with an outer surface of the indentation 138 inside the bottle 124 to stabilize the mixing element 138, such that the mixing element 138 is held more securely in place when the container 100 is shaken.

The various implementations described above can be combined to provide further implementations, Aspects of the implementations can be modified, if necessary to employ concepts of the various patents, applications and publications to provide yet further implementations. Further, a designer having ordinary skill in the art will understand that certain aspects of the disclosure as shown in the Figures, such as balance, symmetry, specific curvatures, and relative lengths of components, may be modified for cosmetic purposes without affecting the function and performance of the product.

These and other changes can be made to the implementations in light of the above-detailed description. In general, in the following claims, the terms used should not be construed to limit the claims to the specific implementations disclosed in the specification and the claims, but should be construed to include all possible implementations along with the full scope of equivalents to which such claims are entitled. Accordingly, the claims are not limited by the disclosure.

1. A hand-holdable container, comprising:
a bottle including a top wall, a side wall, and a bottom wall that define an interior space, an opening in the top wall that is in fluid communication with the interior space, and a first handle formed in the side wall;
a lid that is structured to be threadedly engaged with the top wall of the bottle and to cover the opening in the top wall of the bottle, the lid including a mouth; and
a cap that is structured to be threadedly engaged with the lid and that is sized and shaped to cover the mouth of the lid, the cap including a second handle.

2. The hand-holdable container of claim 1 wherein the first handle is formed at least partially by a cutout that extends through the bottle.

3. A hand-holdable container, comprising:
a bottle having a top wall and an opening in the top wall;
a lid that is structured to be threadedly engaged with the top wall of the bottle in a first rotational direction and to cover the opening in the top wall of the bottle, the lid including a mouth; and
a cap that is sized and shaped to cover the mouth of the lid and to be threadedly engaged with the lid in a second rotational direction that is opposite to the first rotational direction.

4. The hand-holdable container of claim 3 wherein the bottle includes a knob extending upward from the top wall, and wherein the lid includes a releasable latch structured to be locked to the knob.

5. The hand-holdable container of claim 4 wherein the bottle includes a first handle, and wherein the cap includes a second handle.

6. The hand-holdable container of claim 5 wherein the lid includes a strainer that is structured to extend downward into the bottle and wherein the container further includes a mixing element structured to be coupled to the strainer and to extend into the bottom from the strainer.

7. A hand-holdable container, comprising:
a bottle having an interior, a top wall, an opening in the top wall in communication with the interior, and a knob extending upward from the top wall:
a lid that is structured to be threadedly engaged with the top wall of the bottle and to cover the opening in the top wall of the bottle, the lid including a mouth and a releasable latch structured to be locked to the knob; and
a cap that is structured to be threadedly engaged with the lid and to cover the mouth of the lid.

8. The hand-holdable container of claim 7 wherein the releasable latch is structured to prevent rotation of the lid with respect to the bottle when the releasable latch is locked to the knob.

9. The hand-holdable container of claim 8 wherein the releasable latch is structured to permit rotation of the lid with respect to the bottle when the releasable latch is not locked to the knob.

10. A hand-holdable container, comprising:
a bottle having an interior, a top wall, and an opening in the top wall in communication with the interior;
a lid that is structured to be threadedly engaged with the top wall of the bottle and to cover the opening in the top wall of the bottle, the lid including a mouth and a strainer that is structured to extend downward into the bottle;
a mixing element structured to be coupled to the strainer and to extend into the bottle from the strainer; and
a cap that is structured to be threadedly engaged with the lid and to cover the mouth of the lid.

11. The hand-holdable container of claim 10 wherein a bottom end of the mixing element is coupled to a bottom wall of the bottle.

12. The hand-holdable container of claim 11 wherein the bottom end of the mixing element includes a hollow cylindrical rim that extends away from the lid, and wherein the bottom wall of the bottle includes an upwardly-protruding indentation.

13. The hand-holdable container of claim 12 wherein an inner surface of the hollow cylindrical rim is engaged with an outer surface of the upwardly-protruding indentation.

14. The hand-holdable container of claim 13 wherein the engagement of the hollow cylindrical rim with the upwardly-protruding indentation increases the stability of the mixing element.
